(19) United States
(12) Patent Application Publication
(10) Pub. No.: US 2005/0132966 A1
(43) Pub. Date: Jun. 23, 2005

(54) Fowl feeding device

(76) Inventor: Cliff Hartsell, Uvalde, TX (US)

Correspondence Address: LAW OFFICES OF CHRISTOPHER L. MAKAY, 1634 MILAM BUILDING, 115 EAST TRAVIS STREET, SAN ANTONIO, TX, 78205-1763, US

(21) Appl. No.: 10/738,236

(22) Filed: Dec. 17, 2003

(51) Int. Cl. A01K 39/01

(52) U.S. Cl. 119/52.1

(57) ABSTRACT

A fowl feeding device is used to provide a long duration feeding solution in a natural habitat. The feeding device includes a reserve supply of food product to last substantially a month in situations where the fowl are in a natural habitat. The feeding device design prevents large animals from consuming large quantities of the food product, as well as insects, typically ants, from removing the stored food product. The feeding device height is adjustable to enable recently hatched fowl to access the feeding device. Once matured, the fowl feeding device may be raised to further restrict access to other animals.

### RELATED APPLICATION

The present application claims all available benefit, under 35 U.S.C. 119(e), of U.S. provisional patent application Ser. No. 10/606,007, filed Jun. 25, 2003. By this reference, the full disclosure of U.S. provisional patent application Ser. No. 10/606,007 is incorporated herein as though now set forth in its entirety.

### FIELD OF THE INVENTION

The present invention relates to feeding birds and, more particularly, but not by way of limitation, to feeding fowl in a natural environment.

### BACKGROUND OF THE INVENTION

In the bird hunting industry, the production and retention of birds in a predetermined location is key to the continuing success of hunters, as well as to the operators of the hunting establishment. Many hunters return to proven hunting grounds or establishments, on at least an annual basis. The continued operation of the hunting establishment is directly tied to the ability to retain fowl in an immediate area. Those operations that excel at the retention of the fowl will have increased quantities of the fowl, as well as increased chances for reproduction of the fowl.

The retention of the fowl is largely dependent upon the habitat and the availability of food and water sources. In a natural setting, non-migratory fowl are territorial. As such, proper habitats must be established to provide each territory with an appropriate habitat. If an appropriate habitat is not available, the fowl will move to a more correct habitat. Challenges arise when multiple habitats must be created in controlled areas or tracts of land, as changing topography can provide a varied habitat.

Further complications arise when a large number of territories are established, as frequent visits to feed or refill food supply containers spread over numerous acres can prove to be an overwhelming task in itself. The distribution of small quantities of food product is not an efficient means for providing food to a feeder. If large quantities of food are distributed, they are likely be consumed by other animals. As most animals require food and water, it can prove to be challenging to provide continuous food and water sources in a natural setting. Small animals that already live in the natural habitat have access to any food or water source left for the fowl.

Accordingly, a feeding apparatus that provides the fowl with a protected source of food for extended periods in a natural habitat would be beneficial to operators of hunting establishments, as well as those raising large numbers of fowl.

### SUMMARY OF THE INVENTION

In accordance with the present invention, a fowl feeding device is used to provide a long duration feeding solution in a natural habitat. The feeding device includes a reserve supply of food product to last substantially a month in situations where the fowl are in a natural habitat. The feeding device is suspended to prevent large animals from consuming large quantities of the food product, as well as insects, typically ants, from removing the stored food product. The suspension height of the feeding device is adjustable to enable recently hatched fowl to access the feeding device.

The invention further includes shielded dispense apertures to prevent varmints from enlarging the dispense apertures through chewing or gnawing, and thereby gaining access to the stored food product. The feeding device further includes a shroud to shield a dish from the elements.

It is therefore an object of the present invention to provide a long duration fowl feeding device for a natural environment.

It is a further object of the present invention to provide an fowl feeding device that is suspended to deny access to insects, particularly ants.

It is still further an object of the present invention to provide an adjustable suspension height for the fowl feeding device, thereby providing newly hatched fowl with access thereto.

It is yet further an object of the present invention to provide a feeding device with shielded dispense apertures to eliminate the possibility of varmits enlarging the dispense aperture size, thereby gaining access to the food product supply.

Still other objects, features, and advantages of the present invention will become evident to those of ordinary skill in the art in light of the following. Also, it should be understood that the scope of this invention is intended to be broad, and any combination of any subset of the features, elements, or steps described herein is part of the intended scope of the invention.

### BRIEF DESCRIPTION OF THE DRAWINGS

FIG. 1 provides a perspective view of the fowl feeding device according to the preferred embodiment.

FIG. 2a provides an exploded view of the fowl feeding device according to the preferred embodiment illustrating the components thereof.

FIG. 2b provides a perspective view of a hanging support according to the preferred embodiment.

FIG. 3a is a detail view of a dispense cap according to the preferred embodiment.

FIG. 3b is a detail view of the dispense cap with an attached shield according to the preferred embodiment.

FIG. 4 provides a detail view of the cap according to the preferred embodiment.

### DETAILED DESCRIPTION OF THE PREFERRED EMBODIMENT

As required, detailed embodiments of the present invention are disclosed herein; however, it is to be understood that the disclosed embodiments are merely exemplary of the invention, which may be embodied in various forms. It is further to be understood that the figures are not necessarily to scale, and some features may be exaggerated to show details of particular components or steps.

A fowl feeding device is used to provide a long duration feeding solution in a natural habitat. The feeding device includes a reserve supply of food product to last substantially a month in situations where the fowl are in a natural habitat. The feeding device design prevents large animals from consuming large quantities of the food product, as well as insects, typically ants, from removing the stored food product. The feeding device is adjustable to enable recently hatched fowl to access the feeding device. While the fowl feeding device may be suitable for use by different types of fowl, it has been designed primarily for use with quail and quail populations.

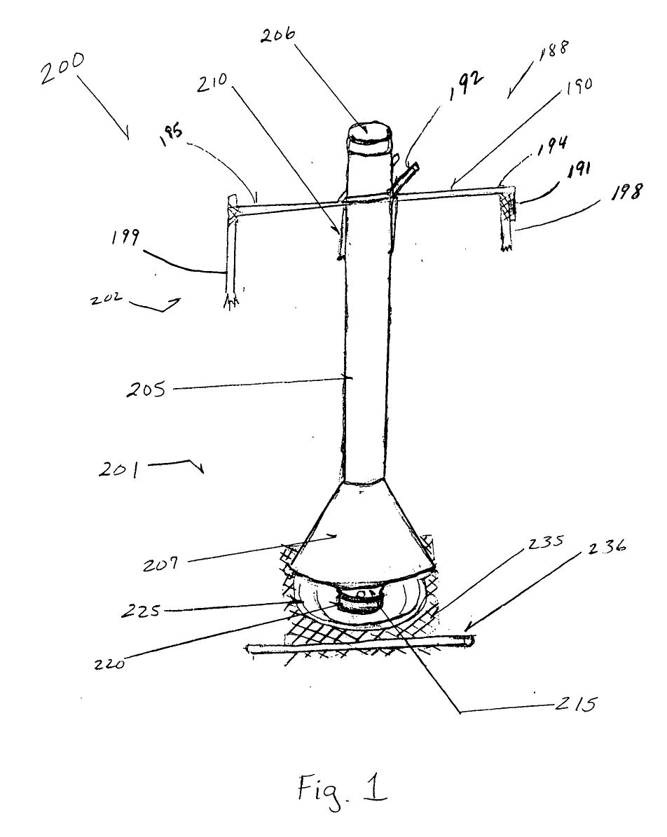

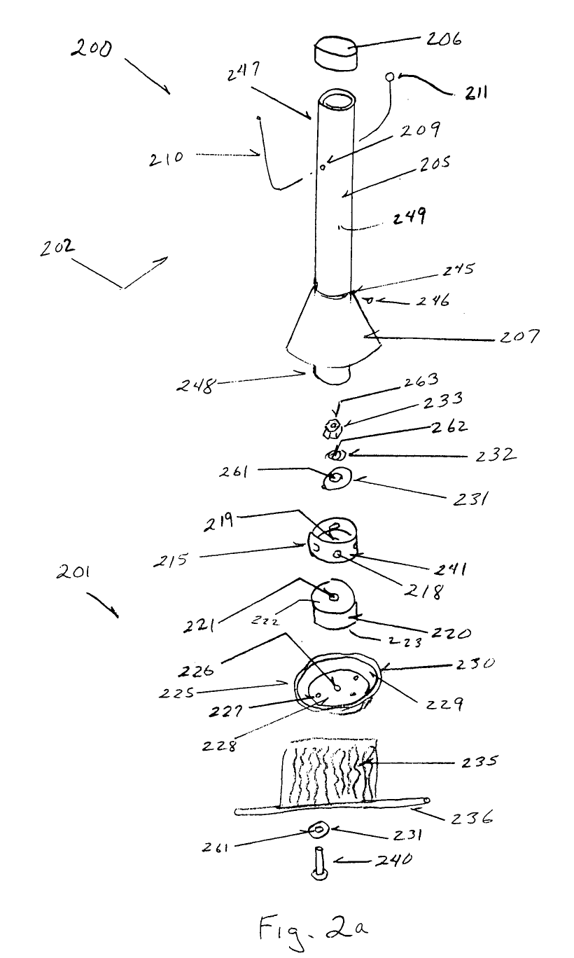

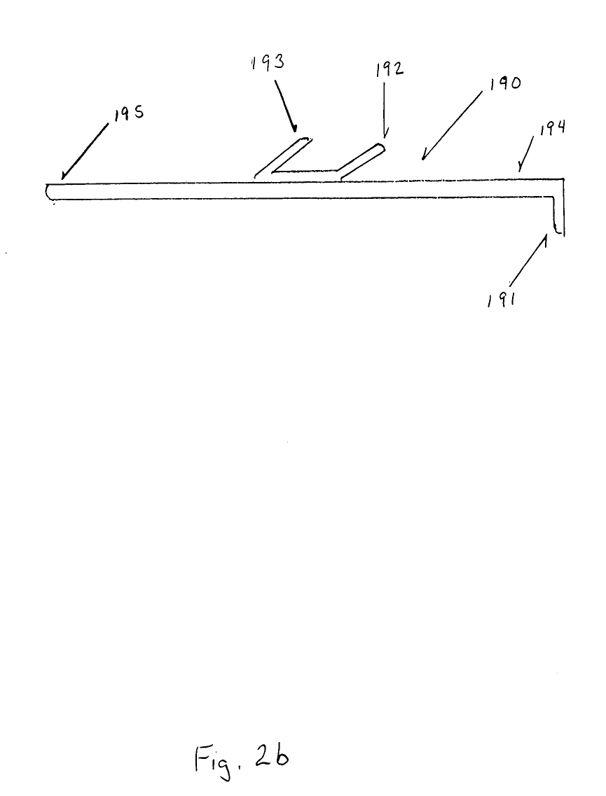

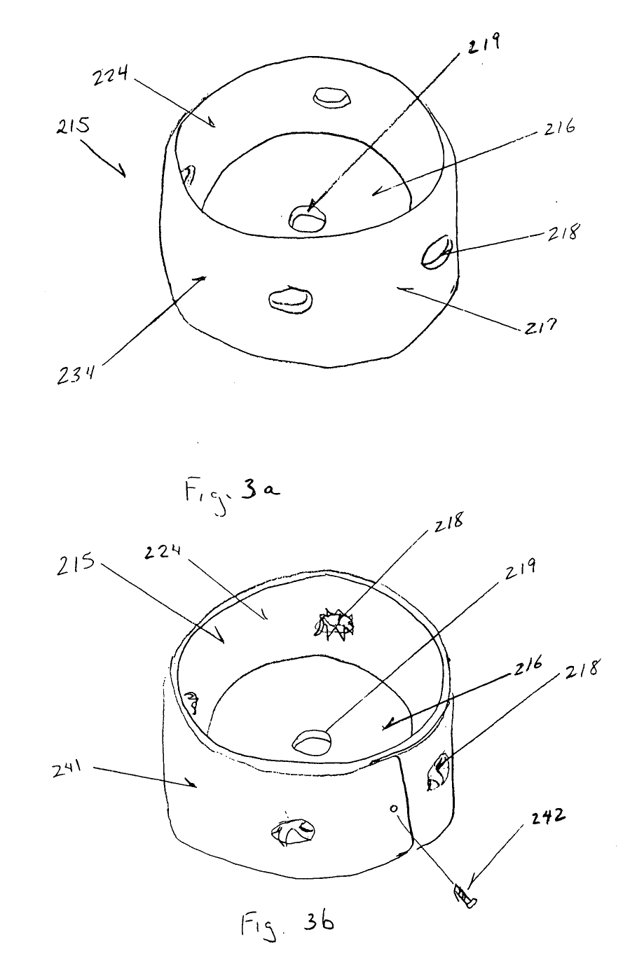

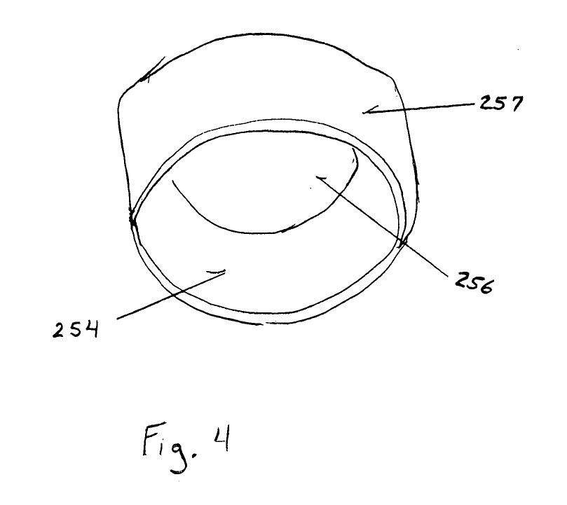

As shown in FIGS. 1-4, a fowl feeding device 200 includes a lower assembly 201, an upper assembly 202, and a hanging assembly 188. The lower assembly 201 includes a landing 235, a perch 236, a dish 225, a riser block 220, and a dispense cap 215. The landing 235 is an essentially square piece of mesh type material, expanded metal in this preferred embodiment. The landing 235 is approximately one foot by one foot in this device, however, one of ordinary skill in the art will recognize that the size and shape of the landing 235 may vary dependent upon the size and quantity of the fowl. The landing 235 is used to provide a resting point for multiple fowl at the feeding device 200, as well as a landing point from flight. The perch 236 is a cylindrical rod used as a resting point for the fowl. In this preferred embodiment, the perch 236 is a wooden dowel, approximately five eighths of an inch in diameter and eighteen inches long. The perch 236 is coupled to an edge of the landing 235, substantially centered on that edge, such that two resting points are provided. The perch 236 may be coupled to the landing using any suitable means, including screws or wire ties.

The dish 225 includes an inner cavity defined by a floor 228, a wall 229, and a lip 230. The lip 230 is raised above the floor 228 to create the inner cavity. The dish 225 is used to retain food product, however, the floor 228 does include drain apertures 227 to allow fluids to exit the inner cavity of the dish 225. The floor 228 further includes a mounting aperture 226 centered in the dish 225. The dish 225 is approximately nine inches in diameter; however, one skilled in the art will recognize that any size dish 225 may be used. The dish 225, in this preferred embodiment, is of sheet metal construction, however, any suitable material may be used, such as plastic.

The riser block 220 includes a first face 222 and a second face 223. The riser block 220 is used to raise the dispense cap 215 above the floor 228 of the dish 225 to a suitable pecking height for the fowl. In this preferred embodiment, the suitable pecking height is in the range of one and a half to two inches. The riser block 220 further includes a mounting aperture 221 centered on the first face 222, and passing through the riser block 220 to the second face 223.

The dispense cap 215 includes a floor 216 coupled to a wall 217, thereby creating an inner cavity. The dispense cap 215 further includes an inner periphery 224, an outer periphery 234, and dispense apertures 218 passing from the inner periphery 224 to the outer periphery 234. The floor 216 includes a mounting aperture 219 located substantially centered in the floor 216. The dispense cap 215, in this preferred embodiment, is constructed of polyvinyl chloride for strength and ease of use. The dispense cap 215 still further includes a shield 241 wrapped around the outer periphery 234 of the dispense cap 215, and secured thereto. The shield 241 may be secured to the dispense cap 215 using any suitable means including sheet metal screws 242. In this preferred embodiment, the shield 241 is constructed from sheet metal, such as galvanized steel. The shield 241 covers the dispense apertures 218, however, the sheet metal covering the dispense apertures 218 is punched with a suitable tool to pierce and splay the sheet metal through the dispense apertures 218, thereby partially lining the edges of the dispense apertures 218. This process provides protection from the enlarging of the dispense apertures 218 by animals seeking food.

The lower assembly 201 further includes a bolt 240, washers 231, a lock washer 232, and a nut 233. The bolt 240 is inserted through an aperture 261 in the washer 231. The bolt 240 is then inserted through approximately the center of the landing 235, through the mounting aperture 226 of the dish 225, through the mounting aperture 221 of the riser block 220, and through the mounting aperture 219 of the floor 216 of the dispense cap 215. Once all the components are aligned properly, an aperture 261 of a second washer 231 is placed over the bolt 240, an aperture 262 of the lock washer 232 is placed over the bolt 240, and a threaded aperture 263 of the nut 233 is threaded onto the bolt 240. The bolt 240 and nut 233 are tightened to secure the components.

The upper assembly 202 includes a product tube 205, a shroud 207, a hanger 210 and a cap 206. The product tube 205 is of a thin wall hollow construction, and includes an outer periphery 249, a first end 247 and a second end 248. In this preferred embodiment, the product tube 205 is constructed from polyvinyl chloride; however, any suitable material may be utilized. The product tube 205 is approximately fifty-seven and one fourth inches long. It should be noted that additional length of the product tube 205 increases the quantity of reserve food product in the feeding device 200. The product tube 205 further includes a hanger aperture 209 on opposite sides of the product tube 205. The hanger apertures 209 are located approximately forty-six inches from the second end of the product tube 205.

The shroud 207 includes a flange 245 used to attach the shroud 207 to the product tube 205. The flange 245 of the shroud 207 is attached to the product tube 205 at approximately ten and one half inches from the second end 248 of the product tube 205 using sheet metal screws 246. The ends of the shroud 207 are connected together to form a continuous shape around the product tube 205. All joints between the shroud 207 and the product tube 205 and the shroud 207 ends are sealed with a sealer, illustratively, RTV, to prevent the seepage of rain down the product tube 205 and into the dish 225. While the shroud 207 may be virtually any size, it should be clear to one skilled in the art that the shroud 207 should be larger than the dish 225, to ensure that water draining off of the shroud 207 does not land in the dish 225.

The cap 206 includes a floor 256, and a wall 257 having an inner periphery 254. The floor 256 is coupled to the wall 257, thereby creating an inner chamber. The inner periphery 254 of the cap 206 is complementary in dimension to the outer periphery 249 of the product tube 205. The cap 206 is constructed of material similar to the material of the product tube 205, illustratively, polyvinyl chloride in this preferred embodiment. The cap 206 resides on the first end 247 of the product tube 205 to protect an inner compartment of the product tube 205. As the cap 206 is removable, no fastening or bonding agent is employed.

Upon further assembly, the second end 248 of the product tube 205 is fit into the inner cavity of the dispense cap 215. The inner periphery 224 of the dispense cap 215 is complementary to the outer periphery 249 of product tube 205. In this preferred embodiment, the product tube 205 and the dispense cap 215 are constructed of a solvent bondable plastic, and are solvent welded together. The assembly is now a single unit with a removable cap 206 and a hanger 210.

The feeding device 200 may be painted for protection from the environment, and blending into the surroundings. Further, a camouflage pattern may be utilized to minimize the impact on the natural setting. In this preferred embodiment, only the upper assembly 201 is camouflaged, however, one skilled in the art will recognize that painting and material color selection may be driven by location specific issues.

The hanging assembly 188 includes a horizontal support 190, a first vertical support 198, and a second vertical support 199. The horizontal support 190 includes a first end 194 and a second end 195. The first end 194 includes a downturn segment 191 that is oriented substantially ninety degrees from the horizontal support 190. The horizontal support 190 further includes first tube stabilizer 192 and a second tube stabilizer 193 attached substantially in the center of the horizontal support 190 in a plane essentially perpendicular to the plane of the downturn segment 191 and the horizontal support 190. The first tube stabilizer 192 and the second tube stabilizer 193 are spaced apart by substantially a product tube 205 diameter, such that the product tube may be placed between the tube stabilizers 192 and 193 for stability along the horizontal support 190.

The first end 194 of the horizontal support 190 may be connected to the first vertical support 198 using any suitable means, such as wire, to secure the downturn segment 191 to the first vertical support 198. Once the downturn segment 191 is secured to the first vertical support 198, the horizontal support 190 is prohibited from rotating. The second end 195 of the horizontal support 190 may be secured to the second vertical support 199. The horizontal support 190 should be secured in a horizontal position to ensure that the feeding device 200 rests in a vertical position. The vertical supports 198 and 199 may constructed of generally available materials, including pipe, t-posts, or the like.

The hanger 210 is inserted into a first hanger aperture 209 and out through a second hanger aperture 209. The hanger 210 is used to suspend the feeding device 200. A ring 211 may be constructed out of the hanger 210 to fit around one of the tube stabilizers 192 or 193. With a ring 211, an operator is able to secure one end of the hanger 210 around one of the stabilizers 192 or 193, thereby allowing the operator to adjust the height of the feeding device 200, by pulling the free end of the hanger 210. Once adjusted to the proper height, the free end may be secured to the unused tube stabilizer 192 or 193. The feeding device 200 may be suspended from the hanging assembly 188 or any suitable object. The hanger 210 is adjustable to allow for raising of the feeding device 200 from a near ground level to approximately one foot above the ground level. Suspending the feeding device 200 minimizes the possibility of ants consuming all the food product in the feeding device 200.

In use, an operator must remove the cap 206 from the first end 247 of the product tube 205, and add a preferred seed or seed blend. Typical seeds used in this preferred embodiment include sorghum grain, corn, premixed blends, and various blends thereof.

The feeding device 200 may then be installed in a preselected area. The operator suspends the feeding device 200 from the hanging assembly 188, such that the landing 235 is approximately four to six inches above the ground level for young fowl. As the fowl increase in size, the feeding device 200 may be raised to a nominal height of twelve inches from the ground level. The suspension of the feeding device 200 prevents pests, namely ants, from exhausting the food product supply. Small animals can easily gain access to the feeding device 200, however, the dispense apertures 218 are sized such that minimal food product can be accessed by the small animals. Further, the shield 241 protects the dispense apertures 218 from being enlarged by the small gnawing animals.

Once installed, the fowl are able to peck at the food product exposed through the dispense apertures 218. The dispense apertures 218, in this preferred embodiment are approximately one-half of an inch in diameter. The fowl consume the food product that is successfully pecked out of the feeding device 200. The food product that ends up falling due to the pecking lands in the dish 225, and can also be consumed by the fowl.

The feeding device 200 ensures that food product is available to fowl for extended periods, approximately one month in this preferred embodiment. While this embodiment has been constructed for use in a natural environment, it should be clear to one skilled in the art that the feeding device 200 may also be used in an enclosed environment, such as a large pen or cage.

Although the present invention has been described in terms of the foregoing preferred embodiment, such description has been for exemplary purposes only and, as will be apparent to those of ordinary skill in the art, many alternatives, equivalents, and variations of varying degrees will fall within the scope of the present invention. That scope, accordingly, is not to be limited in any respect by the foregoing detailed description; rather, it is defined only by the claims that follow.

1. A fowl feeding device, comprising:
a product tube, wherein the product tube accepts a food product at a first end;
a dispense cap coupled to a second end of the product tube, the dispense cap including dispense apertures sized to retain the food product within the product tube, wherein the food product stored in the product tube is available through the dispense apertures and further wherein the food product must be pecked from the dispense apertures by fowl; and
a dish coupled to the dispense cap, wherein food product pecked from the dispense apertures and not consumed collects in the dish.

2. The fowl feeding device according to claim 1, wherein the food product that collects in the dish is available to the fowl for consumption.

3. (canceled)

4. The fowl feeding device according to claim 1, further comprising a cap coupled to the first end of the product tube to protect the food product from the environment.

5. The fowl feeding device according to claim 4, wherein the cap is removable, thereby providing the ability to refill the product tube.

6. The fowl feeding device according to claim 1, further comprising a shroud disposed on the product tube and above the dish to prevent water from falling into the dish.

7. The fowl feeding device according to claim 1, further comprising a shield, wherein the shield lines the dispense apertures, thereby preventing small animals from enlarging the dispense apertures and removing excess amounts of the food product.

8. The fowl feeding device according to claim 1, further comprising a landing disposed beneath the dish for use by the fowl in approaching the feeding device.

9. The fowl feeding device according to claim 1, wherein the dish includes drain holes to prevent liquids from accumulating in the dish.

10. The fowl feeding device according to claim 1, further comprising a hanging assembly used to suspend and stabilize the fowl feeding device.

11. The fowl feeding device according to claim 10, wherein the suspension height of the fowl feeding device is adjustable to accommodate non matured fowl.

12. The fowl feeding device according to claim 10, wherein the hanging assembly comprises a hanger that is adjustable.

13. The fowl feeding device according to claim 10, wherein the hanging assembly comprises a horizontal support with a downturn segment for rotational stability.

14. The fowl feeding device according to claim 13, wherein the horizontal support comprises tube stabilizers to prevent movement of the feeding device along the horizontal support.

15. The fowl feeding device according to claim 13, wherein the hanging assembly comprises at least one vertical support used to elevate the horizontal support and the fowl feeding device.

16. The fowl feeding device according to claim 10, wherein the suspension of the fowl feeding device prevents insects from accessing the feeding device and any stored product.

17. The fowl feeding device according to claim 1, further comprising a riser block secured to the dish and supporting the dispense cap thereon, thereby raising the dispense cap to a suitable pecking height for fowl.
